(19) United States
(12) Patent Application Publication
(10) Pub. No.: US 2024/0175721 A1
(43) Pub. Date: May 30, 2024

(54) APPARATUS AND METHOD FOR DETECTING POSITION OF RACK BAR IN MOTOR DRIVEN POWER STEERING SYSTEM

(71) Applicant: HYUNDAI MOBIS CO., LTD., Seoul (KR)

(72) Inventors: Tae Jun WEON, Yongin-si (KR); Suk Won LEE, Yongin-si (KR)

(73) Assignee: HYUNDAI MOBIS CO., LTD., Seoul (KR)

(21) Appl. No.: 18/511,366

(22) Filed: Nov. 16, 2023

(30) Foreign Application Priority Data
Nov. 28, 2022 (KR) 10-2022-0161470

(51) Int. Cl. G01D 5/14; B62D 5/04; B62D 15/02

(52) U.S. Cl. CPC G01D 5/145; B62D 5/04; B62D 15/0225

(57) ABSTRACT

An apparatus for detecting a position of a rack bar in a motor driven power steering system include a first magnetic sensor disposed on a rack housing, the first magnetic sensor being configured to generate a first signal by detecting magnetism generated by magnets disposed on a rack bar, a second magnetic sensor disposed on the rack housing and spaced apart from the first magnetic sensor, the second magnetic sensor being configured to generate a second signal by detecting the magnetism generated by the magnets, and a processor configured to calculate the position of the rack bar based on the first signal and the second signal.

### CROSS-REFERENCE TO RELATED APPLICATION

This application claims priority from and the benefit under 35 USC § 119(a) of Korean Patent Application No. 10-2022-0161470, filed on Nov. 28, 2022, the entire disclosure of which is incorporated herein by reference for all purposes.

### BACKGROUND

### 1. Field

Exemplary embodiments of the present disclosure relate to an apparatus and method for detecting the position of a rack bar in a motor driven power steering system and, more particularly, to an apparatus and method for detecting the position of a rack bar in a motor driven power steering system, the apparatus and method being able to detect the position of the rack bar included in the motor driven power steering system.

### 2. Description of the Related Art

In general, as a power assisted steering system of a vehicle, a hydraulic power steering system using hydraulic pressure of a hydraulic pump is used. However, after 1990s, a motor driven power steering (MDPS) system using an electric motor has gradually become more common.

In conventional hydraulic power steering systems, a hydraulic pump which is a power source serving to provide steering assistance power is driven by the engine to constantly consume energy regardless of whether or not the steering wheel rotates. In contrast, in motor driven power steering systems, when the steering wheel rotates and torque is generated, a motor is driven by electrical energy to provide steering assistance power.

Thus, when a motor driven power steering system (or motor driven power steering device) is used, the energy efficiency of a vehicle can be advantageously improved compared to a vehicle in which a hydraulic power steering device is used.

In addition, autonomous vehicles under recent development are being designed with the goal of minimizing the turning radius in order to enable various motions such as crab walk and parallel parking. In order to reduce the turning radius of a vehicle, it is necessary to increase the stroke length of a rack bar included in the motor driven power steering system. In the related art, there is a problem in that limitation is the stroke length of the rack bar the position of which is detectable. Accordingly, there is a demand for an apparatus and method able to increase the stroke length of a rack bar the position of which is detectable.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an apparatus for detecting a position of a rack bar in a motor driven power steering system including a first magnetic sensor disposed on a rack housing, the first magnetic sensor being configured to generate a first signal by detecting magnetism generated by magnets disposed on a rack bar, a second magnetic sensor disposed on the rack housing and spaced apart from the first magnetic sensor, the second magnetic sensor being configured to generate a second signal by detecting the magnetism generated by the magnets, and a processor configured to calculate the position of the rack bar based on the first signal and the second signal.

The processor may be configured to calculate a mean value of the first signal and the second signal and calculate a position of the rack bar based on the calculated mean value.

The apparatus may include a memory storing relationship information, the relationship information including mean values of the first signal and the second signal according to the position of the rack bar, the processor being further configured to calculate the position of the rack bar by detecting the position of the rack bar corresponding to the calculated mean value from the relationship information stored in the memory.

The first magnetic sensor and the second magnetic sensor may be disposed symmetrically about a center of a stroke of the rack bar.

The first magnetic sensor may be disposed such that the center and one end of the stroke of the rack bar are provided in a first sensing range of the first magnetic sensor and the second magnetic sensor may be disposed such that the center and an other end of the stroke of the rack bar are provided in a second sensing range of the second magnetic sensor.

In a general aspect, here is provided a method of detecting a position of a rack bar in a motor driven power steering system including calculating a mean value of a first signal generated by a first magnetic sensor disposed on a rack housing and configured to detect magnetism generated by magnets disposed on the rack bar and a second signal generated by a second magnetic sensor disposed on the rack housing and spaced apart from the first magnetic sensor, the second magnetic sensor being configured to detect the magnetism generated by the magnets and calculating a position of the rack bar based on the mean value.

In the calculation of the position of the rack bar, the position of the rack bar may be calculated based on the calculated mean value from predetermined relationship information regarding mean values of the first and second signals according to the position of the rack bar.

The first magnetic sensor and the second magnetic sensor may be disposed symmetrically about a center of a stroke of the rack bar.

The first magnetic sensor may be disposed such that the center and one end of the stroke of the rack bar are provided in a sensing range of the first magnetic sensor and the second magnetic sensor may be disposed such that the center and the other end of the stroke of the rack bar are provided in a sensing range of the second magnetic sensor.

In a general aspect, here is provided an apparatus including one or more processors configured to calculate a position of a rack bar based on a first input from a first magnetic sensor, the first magnetic sensor being configured to measure magnetism generated by magnets disposed on the rack bar, and a second input from a second magnetic sensor, the second magnetic sensor being spaced apart from the first magnetic sensor and configured to measure the magnetism from the magnets disposed on the rack bar.

The calculation of the position of the rack bar may be based on a calculated mean value of the first input and the second input.

A center and a first end of a stroke of the rack bar may be provided in a first sensing range of the first magnetic sensor and the center and a second end of the stroke of the rack bar may be provided in a second sensing range of the second magnetic sensor.

The first magnetic sensor may be a Hall effect sensor.

The second magnetic sensor may be a Hall effect sensor.

The first magnetic sensor may be disposed symmetrically about a center of a stroke of the rack bar with respect to the second magnetic sensor.

### BRIEF DESCRIPTION OF THE DRAWINGS

FIG. 1 is a block diagram illustrating the configuration of an apparatus for detecting the position of a rack bar in a motor driven power steering system according to an embodiment of the present disclosure;

FIGS. 2A and 2B are example diagrams illustrating the apparatus for detecting the position of a rack bar in a motor driven power steering system according to an embodiment of the present disclosure.

FIGS. 3A and 3B are example graphs illustrating necessity for optimization of the positions of the first and second magnetic sensors according to an embodiment of the present disclosure.

FIGS. 4A and 4B are example graphs illustrating first and second signals according to an embodiment of the present disclosure.

FIG. 5 is an example diagram illustrating a case in which the positions of the first and second magnetic sensors according to an embodiment of the present disclosure are optimized.

FIGS. 6A and 6B are example diagrams illustrating the performance of the apparatus for detecting the position of a rack bar in a motor driven power steering system according to an embodiment of the present disclosure.

FIG. 7 is a flowchart illustrating a method of detecting the position of a rack bar in a motor driven power steering system according to an embodiment of the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

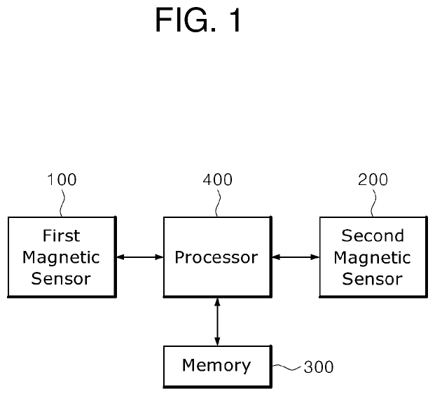

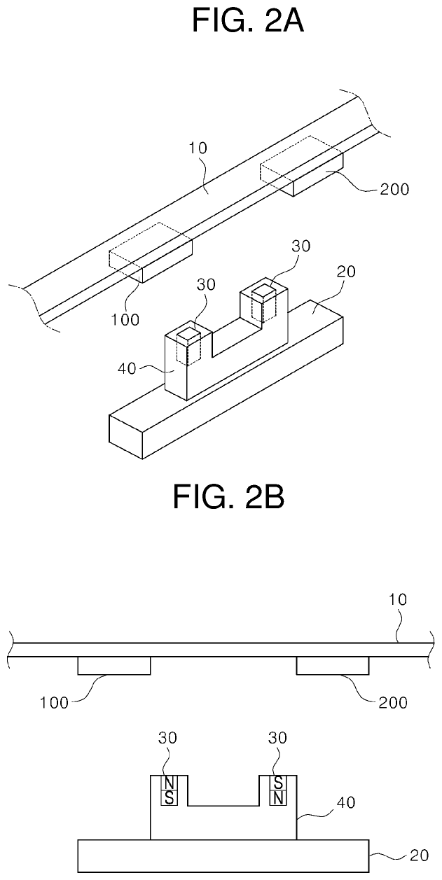

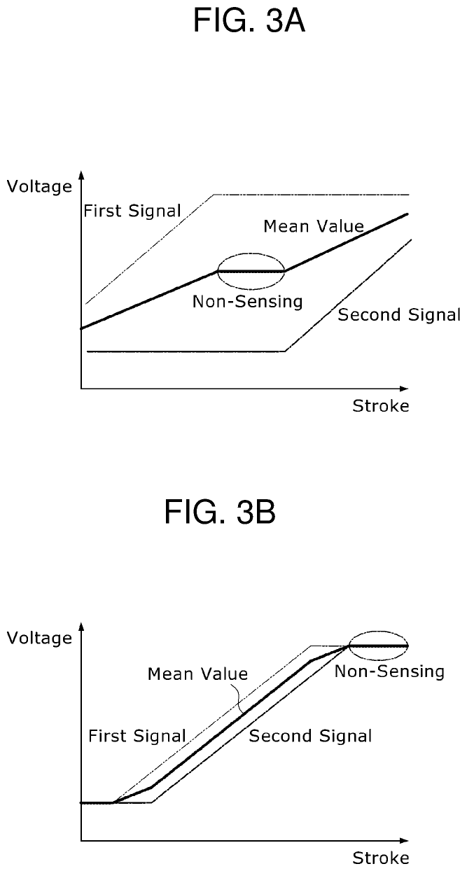

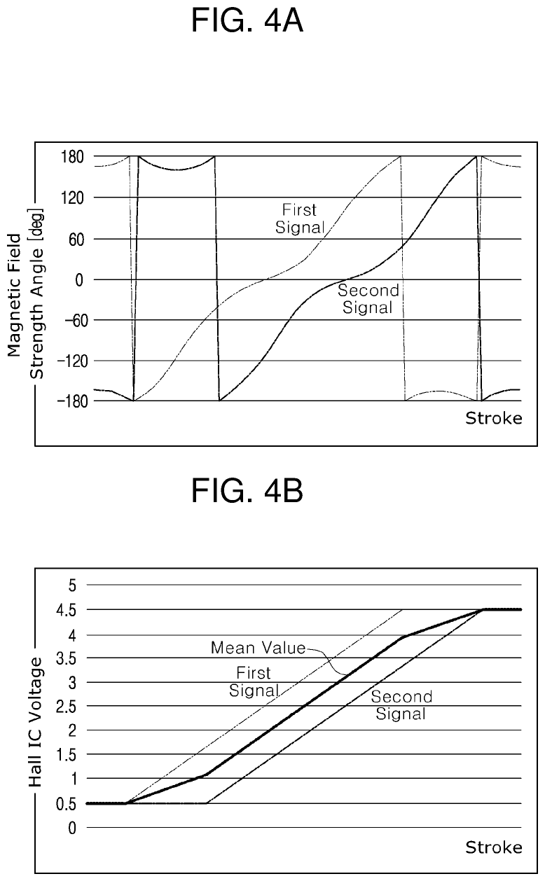

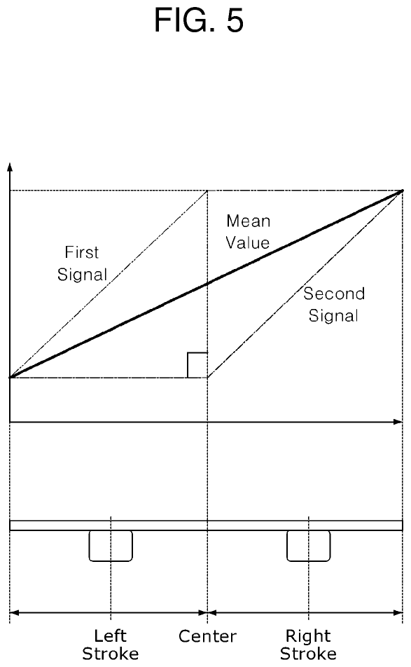

FIG. 1 is a block diagram illustrating the configuration of an apparatus for detecting the position of a rack bar in a motor driven power steering system according to an embodiment of the present disclosure, FIGS. 2A and 2B are example diagrams illustrating the apparatus for detecting the position of a rack bar in a motor driven power steering system according to an embodiment of the present disclosure, FIGS. 3A and 3B are example graphs illustrating necessity for optimization of the positions of the first and second magnetic sensors according to an embodiment of the present disclosure, FIGS. 4A and 4B are example graphs illustrating first and second signals according to an embodiment of the present disclosure, and FIG. 5 is an example diagram illustrating a case in which the positions of the first and second magnetic sensors according to an embodiment of the present disclosure are optimized.

Referring to FIGS. 1, 2A, and 2B, the apparatus for detecting the position of a rack bar in a motor driven power steering system according to an embodiment of the present disclosure may include a first magnetic sensor 100, a second magnetic sensor 200, a memory 300, and a processor 400. The apparatus for detecting the position of a rack bar in a motor driven power steering system according to an embodiment of the present disclosure may further include a variety of components other than the components illustrated in FIG. 1 or some of these components may be omitted.

The first magnetic sensor 100 may be disposed on a rack housing 10 to generate a first signal by detecting magnetism generated by magnets 30 disposed on a rack bar 20. As illustrated in FIGS. 2A and 2B, the magnets 30 may be disposed on the rack bar 20. A magnet holder 40 may be coupled to the rack bar 20, and a plurality of magnets 30 may be accommodated in the magnet holder 40. For example, two magnets 30 may be accommodated in the magnet holder 40 while being spaced apparat from each other. In this case, the two magnets 30 accommodated in the magnet holder 40 may be in opposite directions. The first magnetic sensor 100 may be disposed on the rack housing 10 provided to accommodate the rack bar 20. The first magnetic sensor 100 may be disposed at a position facing the magnets 30. The first magnetic sensor 100 may be, for example, a Hall effect sensor. The first magnetic sensor 100 may generate the first signal by detecting a change in a magnetic field in response to the movement of the rack bar 20 and output the generated first signal to the processor 400 described below.

The second magnetic sensor 200 may be disposed on the rack housing 10 and spaced apart from the first magnetic sensor 100 to generate a second signal by detecting magnetism generated by the magnets 30 disposed on the rack bar 20. The second magnetic sensor 200 may be disposed at a position spaced apart from the first magnetic sensor 100 by a predetermined distance in the longitudinal direction of the rack bar 20. The second magnetic sensor 200 may be disposed at a position facing the magnets 30. The second magnetic sensor 200 may be, for example, a Hall effect sensor. The second magnetic sensor 200 may generate the second signal by detecting a change in a magnetic field in response to the movement of the rack bar 20 and output the generated second signal to the processor 400.

The first and second magnetic sensors 100 and 200 may be disposed symmetrically about the center of the stroke of the rack bar 20. Here, the center of the stroke of the rack bar 20 may indicate the center of the rack bar 20 when the steering angle of the vehicle is 0°. That is, in a state in which the rack bar 20 is not biased in any one direction, left or right, the center of the rack bar 20 may correspond to the center of the stroke of the rack bar 20. The first and second magnetic sensors 100 and 200 may be disposed at positions spaced from the center of the stroke of the rack bar 20 by the same distances. For example, the first magnetic sensor 100 may be disposed at a position spaced to the left from the center of the stroke of the rack bar 20 by a distance A, while the second magnetic sensor 200 may be disposed at a position spaced to the right from the center of the stroke of the rack bar 20 by the distance A.

In addition, as can be seen from details described below, the present disclosure calculates the position of the rack bar 20 using a mean value of the first signal generated by the first magnetic sensor 100 and the second signal generated by the second magnetic sensor 200. In order to calculate the position of the rack bar 20 in this manner, it is necessary for the mean value of the first and second signals according to the position of the rack bar to be linear. In order for the mean value of the first and second signals to be linear, the first and second magnetic sensors 100 and 200 are required to be disposed at appropriate positions.

For example, as illustrated in FIG. 3A, when the first and second magnetic sensors 100 and 200 are disposed to be excessively spaced apart from each other, the linearity of the mean value of the first and second signals is not maintained in the middle section of the stroke of the rack bar 20 and thus a non-sensing area in which the position of the rack bar 20 cannot be sensed is formed. In addition, as illustrated in FIG. 3B, when the first and second magnetic sensors 100 and 200 are disposed to be excessively close to each other, the linearity of the mean value of the first and second signals is not maintained in the end section of the stroke of the rack bar 20 and thus a non-sensing area in which in which the position of the rack bar 20 cannot be sensed is formed.

Thus, the first magnetic sensor 100 may be disposed such that the center of the stroke of the rack bar 20 and one end (e.g., the left end) of the stroke of the rack bar 20 are included in the sensing range of the first magnetic sensor 100, and the second magnetic sensor 200 may be disposed such that the center of the stroke of the rack bar 20 and the other end (e.g., the right end) of the stroke of the rack bar 20 are included in the sensing range of the second magnetic sensor 200. That is, as illustrated in FIGS. 4A and 4B, the linearity of the mean value of the first and second signals may be maintained over the entire sections of the stroke of the rack bar 20 by setting the center and one end of the stroke of the rack bar 20 to be included in the range in which the magnetism generated by the magnets 30 can be detected by the first magnetic sensor 100 and the center and the other end of the stroke of the rack bar 20 to be included in the range in which the magnetism generated by the magnets 30 can be detected by the second magnetic sensor 200. Thus, the position of the rack bar 20 can be detected over the entire sections of the stroke of the rack bar 20.

In addition, after the first magnetic sensor 100 is disposed, the settings of the first magnetic sensor 100 may be changed. Here, the settings of the first magnetic sensor 100 may be changed so that the minimum value is output when the rack bar 20 is located at one end (e.g., the left end) of the stroke and the maximum value is output when the rack bar 20 is located at the center of the stroke. After the second magnetic sensor 200 is disposed, the settings of the second magnetic sensor 200 may be changed. Here, the settings of the second magnetic sensor 200 may be changed so that the minimum value is output when the rack bar 20 is located at the center of the stroke and the maximum value is output when the rack bar 20 is located at the other end (e.g., the right end) of the stroke.

For example, as illustrated in FIG. 5, the first magnetic sensor 100 may be disposed at the center of the left stroke formed left to the center of the stroke of the rack bar 20, and the second magnetic sensor 200 may be disposed at the center of the right stroke formed right to the center of the stroke of the rack bar 20. Here, the first magnetic sensor 100 may be set to output the minimum value at the left end of the left stroke and the maximum value at the center of the stroke, while the second magnetic sensor 200 may be set to output the minimum value at the center of the stroke and output the maximum value at the right end of the right stroke. That is, in the range from the left end of the left stroke to the right end of the left stroke (i.e., the center of the stroke of the rack bar 20) a signal having a magnetic field strength angle of −180 to 180° may be detected by the first magnetic sensor 100. In the range from the left end of the right stroke (i.e., the center of the stroke of the rack bar 20) to the right end of the right stroke signal, a signal having a magnetic field strength angle of −180 to 180° may be detected by the second magnetic sensor 200.

The placement positions of the first and second magnetic sensors 100 and 200 for meeting the above-described conditions are described in the foregoing embodiment, but the placement positions of the magnets 30 may be adjusted in order to meet the above-described conditions.

The memory 300 may have various information required during operation of the processor 400 stored therein. Various information calculated during operation of the processor 400 may also be stored in the memory 300. According to an embodiment, relationship information regarding mean values of the first signal and the second signal according to the position of the rack bar 20 may be stored in the memory 300. The relationship information stored in the memory 300 may be used to calculate the position of the rack bar 20.

The processor 400 may be operably connected to the first magnetic sensor 100, the second magnetic sensor 200, and the memory 300. The processor 400 may be implemented as a central processing unit (CPU), a digital signal processor (DSP), a micro controller unit (MCU), or a system on chip (SoC). The processor 400 may be configured to control a plurality of hardware or software components connected to the processor 400 by driving an operating system or an application, perform a variety of data processing operations and calculations, and execute at least one command stored in the memory 300 and store result data of the execution in the memory 300.

The processor 400 may calculate the mean value of the first signal generated by the first magnetic sensor 100 and the second signal generated by the magnetic sensor 200, and calculate the position of the rack bar 20 on the basis of the calculated mean value. That is, the processor 400 may calculate the position of the rack bar 20 using the mean value of the first signal generated by the first magnetic sensor 100 by detecting the magnetism generated by the magnets 30 and the second signal generated by the second magnetic sensor 200 by detecting the magnetism generated by the magnets 30.

The processor 400 may calculate the position of the rack bar 20 by detecting the position of the rack bar 20 corresponding to the mean value calculated previously from the relationship information regarding the mean values of the first and second signals according to the position of the rack bar 20 stored in the memory 300. That is, the mean values of the first and second signals according to the position of the rack bar 20 may be previously calculated and stored in the memory 300, and the processor 400 may detect the position of the rack bar 20 using the mean value of the first and second signals calculated at the corresponding time point by referring to the information stored in the memory 300.

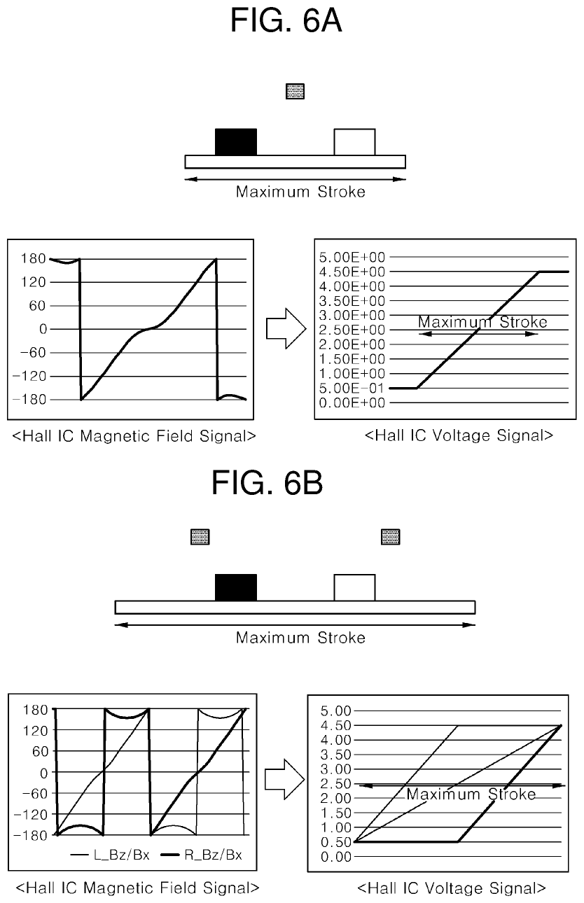

FIGS. 6A and 6B are example diagrams illustrating the performance of the apparatus for detecting the position of a rack bar in a motor driven power steering system according to an embodiment of the present disclosure. As illustrated in FIG. 6A, in a conventional apparatus for detecting the position of a rack bar, the range in which the position of the rack bar 20 is detectable (i.e., the length of the stroke in which the position is detectable) is limited. In contrast, as illustrated in FIG. 6B, it can be seen that the range in which the position of the rack bar 20 is detectable according to the present disclosure is increased compared to that of the conventional technology.

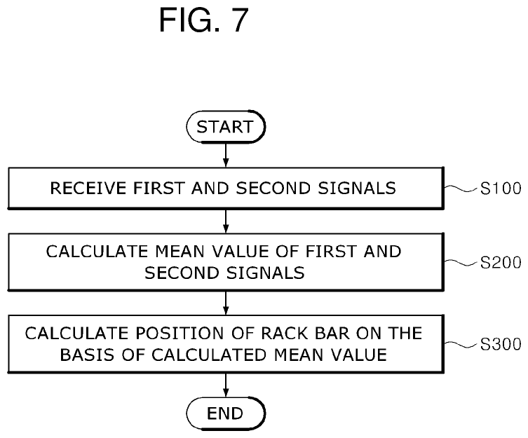

FIG. 7 is a flowchart illustrating a method of detecting the position of a rack bar in a motor driven power steering system according to an embodiment of the present disclosure.

Hereinafter, with reference to FIG. 7, a method of detecting the position of a rack bar in a motor driven power steering system according to an embodiment of the present disclosure will be described. Some of the following processes may be performed in an order different from the following order or be omitted. In addition, hereinafter, the present disclosure will be described mainly with regard to the time-sequence configuration thereof by omitting detailed descriptions of the portions substantially the same as those described above.

First, the processor 400 may receive a first signal generated by the first magnetic sensor 100 disposed on the rack housing 10 to detect magnetism generated by the magnets 30 and a second signal generated by the second magnetic sensor 200 disposed on the rack housing 10 and spaced apart from the first magnetic sensor 100 to detect the magnetism generated by the magnets 30 in S100.

Subsequently, the processor 400 may calculate a mean value of the received first and second signals in S200. The processor 400 may calculate the mean value of the first signal and the second signal by summing the first signal and the second signal and halving the sum of the signals.

Afterwards, the processor 400 may calculate the position of the rack bar 20 on the basis of the calculated mean value in S300. The processor 400 may calculate the position of the rack bar 20 by detecting the position of the rack bar 20 corresponding to the mean value of the first signal output from the first magnetic sensor 100 and the second signal output from the second magnetic sensor 200, on the basis of relationship information regarding the position of the rack bar 20 according to mean values of the first and second signals stored in the memory 300. The position of the rack bar 20 calculated by the processor 400 may be output to the outside to be used to control the motor driven power steering system.

As described above, the apparatus and method for detecting the position of a rack bar in a motor driven power steering system according to embodiments of the present disclosure may detect the position of the rack bar using two magnetic sensors disposed on the rack housing and spaced apart from each other, thereby increasing the range in which the position of the rack bar is detectable.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for detecting a position of a rack bar in a motor driven power steering system, the apparatus comprising:
a first magnetic sensor disposed on a rack housing, the first magnetic sensor being configured to generate a first signal by detecting magnetism generated by magnets disposed on a rack bar;
a second magnetic sensor disposed on the rack housing and spaced apart from the first magnetic sensor, the second magnetic sensor being configured to generate a second signal by detecting the magnetism generated by the magnets; and
a processor configured to calculate the position of the rack bar based on the first signal and the second signal.

2. The apparatus of claim 1, wherein the processor is further configured to:
calculate a mean value of the first signal and the second signal; and
calculate a position of the rack bar based on the calculated mean value.

3. The apparatus of claim 2, further comprising:
a memory storing relationship information, the relationship information including mean values of the first signal and the second signal according to the position of the rack bar,
wherein the processor is further configured to calculate the position of the rack bar by detecting the position of the rack bar corresponding to the calculated mean value from the relationship information stored in the memory.

4. The apparatus of claim 1, wherein the first magnetic sensor and the second magnetic sensor are disposed symmetrically about a center of a stroke of the rack bar.

5. The apparatus of claim 4, wherein the first magnetic sensor is disposed such that the center and one end of the stroke of the rack bar are provided in a first sensing range of the first magnetic sensor, and
wherein the second magnetic sensor is disposed such that the center and an other end of the stroke of the rack bar are provided in a second sensing range of the second magnetic sensor.

6. A method of detecting a position of a rack bar in a motor driven power steering system, the method comprising:
calculating a mean value of a first signal generated by a first magnetic sensor disposed on a rack housing and configured to detect magnetism generated by magnets disposed on the rack bar and a second signal generated by a second magnetic sensor disposed on the rack housing and spaced apart from the first magnetic sensor, the second magnetic sensor being configured to detect the magnetism generated by the magnets; and
calculating a position of the rack bar based on the mean value.

7. The method of claim 6, wherein, in the calculation of the position of the rack bar, the position of the rack bar is calculated based on the calculated mean value from predetermined relationship information regarding mean values of the first and second signals according to the position of the rack bar.

8. The method of claim 6, wherein the first magnetic sensor and the second magnetic sensor are disposed symmetrically about a center of a stroke of the rack bar.

9. The method of claim 8, wherein the first magnetic sensor is disposed such that the center and one end of the stroke of the rack bar are provided in a sensing range of the first magnetic sensor, and
wherein the second magnetic sensor is disposed such that the center and the other end of the stroke of the rack bar are provided in a sensing range of the second magnetic sensor.

10. An apparatus, comprising:
one or more processors configured to calculate a position of a rack bar based on a first input from a first magnetic sensor, the first magnetic sensor being configured to measure magnetism generated by magnets disposed on the rack bar, and a second input from a second magnetic sensor, the second magnetic sensor being spaced apart from the first magnetic sensor and configured to measure the magnetism from the magnets disposed on the rack bar.

11. The apparatus of claim 10, wherein the calculation of the position of the rack bar is based on a calculated mean value of the first input and the second input.

12. The apparatus of claim 10, wherein a center and a first end of a stroke of the rack bar are provided in a first sensing range of the first magnetic sensor, and
wherein the center and a second end of the stroke of the rack bar are provided in a second sensing range of the second magnetic sensor.

13. The apparatus of claim 10, wherein the first magnetic sensor comprises a Hall effect sensor.

14. The apparatus of claim 10, wherein the second magnetic sensor comprises a Hall effect sensor.

15. The apparatus of claim 10, wherein the first magnetic sensor is disposed symmetrically about a center of a stroke of the rack bar with respect to the second magnetic sensor.
